(19) United States
(12) Patent Application Publication
(10) Pub. No.: US 2021/0178581 A1
(43) Pub. Date: Jun. 17, 2021

(54) REMOTE CONTROL SYSTEM AND REMOTE CONTROL METHOD

(71) Applicant: TOYOTA JIDOSHA KABUSHIKI KAISHA, Toyota-shi (JP)

(72) Inventor: Takashi YAMAMOTO, Toyota-shi (JP)

(73) Assignee: TOYOTA JIDOSHA KABUSHIKI KAISHA, Toyota-shi (JP)

(21) Appl. No.: 17/087,973

(22) Filed: Nov. 3, 2020

(30) Foreign Application Priority Data
Dec. 13, 2019 (JP) 2019-225286

(51) Int. Cl. B25J 9/16; G06T 1/00; H04L 12/58; G06K 9/00; G06F 3/0488; B25J 13/00; B25J 13/08

(52) U.S. Cl. CPC B25J 9/1658; G06T 1/0014; H04L 51/16; G06K 9/00671; B25J 9/1697; B25J 13/006; B25J 9/1669; B25J 13/08; G06F 3/04883

(57) ABSTRACT

A remote control system includes: an imaging unit that shoots an environment in which a device to be operated including an end effector is located; an operation terminal having a function for displaying a shot image of the environment shot by the imaging unit and receiving handwritten input information input to the displayed shot image, and allowing a user to have a conversation with the device to be operated through a text chat; and an estimation unit that estimates an object to be grasped which has been requested to be grasped by the end effector and estimates a way of performing a grasping motion by the end effector based on the handwritten input information input to the shot image and a conversation history of the text chat, the grasping motion having been requested to be performed with regard to the object to be grasped.

### CROSS REFERENCE TO RELATED APPLICATIONS

This application is based upon and claims the benefit of priority from Japanese patent application No. 2019-225286, filed on Dec. 13, 2019, the disclosure of which is incorporated herein in its entirety by reference.

### BACKGROUND

The present disclosure relates to a remote control system and a remote control method.

A technique is known in which a user remotely operates a device to be operated including an end effector, such as a robot or the like including a grasping part (e.g., a hand or a suction part) at the tip of its arm as an end effector, to thereby cause the device to be operated to perform a grasping motion or the like. For example, Japanese Patent No. 5326794 discloses a technique for displaying a shot image obtained by shooting the periphery of a robot and then estimating a content of an operation to be performed by the robot based on an instruction input to the shot image by a user by handwriting.

### SUMMARY

However, the technique disclosed in Japanese Patent No. 5326794 is a technique for remotely controlling a robot by inputting predetermined instruction figures (∘, x, Δ, etc.) by handwriting. Therefore, there has recently been a demand for a technique for enabling a user to provide instructions for a task which a user wants the device to be operated to execute among tasks that can be executed by the device to be operated by using an intuitive user interface.

The present disclosure has been made to solve the above-described problem, and it provides a remote control system and a remote control method that enable a more intuitive operation.

A first exemplary aspect is a remote control system configured to remotely control a device to be operated including an end effector, the remote control system including:

an imaging unit configured to shoot an environment in which the device to be operated is located;

an operation terminal having a function for displaying a shot image of the environment shot by the imaging unit and receiving handwritten input information input to the displayed shot image, and allowing a user to have a conversation with the device to be operated through a text chat; and

an estimation unit configured to, based on the handwritten input information input to the shot image and a conversation history of the text chat, estimate an object to be grasped which has been requested to be grasped by the end effector and estimate a way of performing a grasping motion by the end effector, the grasping motion having been requested to be performed with regard to the object to be grasped.

Another exemplary aspect is a remote control method performed by a remote control system configured to remotely control a device to be operated including an end effector, the remote control method including:

shooting an environment in which the device to be operated is located;

receiving, by an operation terminal displaying a shot image of the environment, handwritten input information input to the displayed shot image;

causing the device to be operated to have a conversation with a user of the operation terminal through a text chat; and

based on the handwritten input information input to the shot image and a conversation history of the text chat, estimating an object to be grasped which has been requested to be grasped by the end effector and estimating a way of performing a grasping motion by the end effector, the grasping motion having been requested to be performed with regard to the object to be grasped.

According to the above-described aspects of the present disclosure, it is possible to provide a remote control system and a remote control method that enable a more intuitive operation.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a conceptual diagram showing an example of an overall environment in which a remote control system according to an embodiment is used;

FIG. 2 shows an example of a display screen displayed on a display panel of a remote terminal;

FIG. 3 shows an example of the display screen displayed on the display panel of the remote terminal;

FIG. 4 shows an example of the display screen displayed on the display panel of the remote terminal;

FIG. 5 is an external perspective view showing an example of an external configuration of a robot;

FIG. 6 is a block diagram showing an example of a block configuration of the robot;

FIG. 7 shows an example of a shot image acquired by the robot;

FIG. 8 shows an example of an area that can be grasped which a learned model outputs;

FIG. 9 is a block diagram showing an example of a block configuration of the remote terminal;

FIG. 10 is a flowchart showing an example of an overall flow of processes performed by the remote control system according to the embodiment;

FIG. 11 shows an example of the display screen displayed on the display panel of the remote terminal; and

FIG. 12 shows an example of the display screen displayed on the display panel of the remote terminal.

### DESCRIPTION OF EMBODIMENTS

Hereinafter, although the present disclosure will be described with reference to embodiment of the present disclosure, the present disclosure according to claims is not limited to the following embodiment. Further, all the components described in the following embodiment are not necessarily essential as means for solving problems. Further, in the following embodiment, a robot including a hand at the tip of its arm as an end effector will be described as an example of a device to be operated, but the device to be operated is not limited thereto.

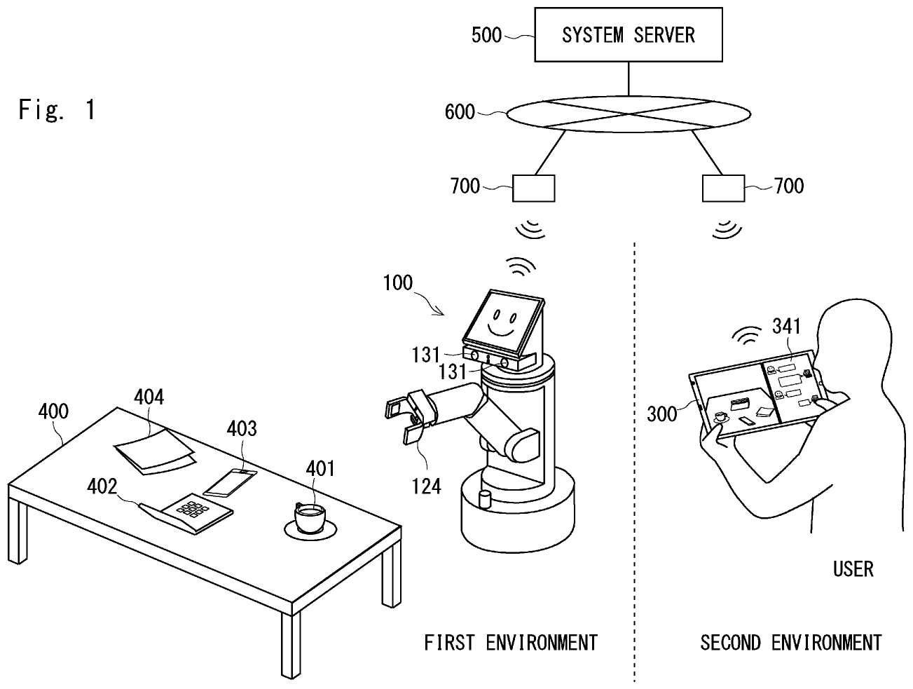

FIG. 1 is a conceptual diagram showing an example of an overall environment in which a remote control system 10 according to this embodiment is used. A robot 100 that performs various kinds of motions in a first environment is remotely controlled via a system server 500 connected to an Internet 600 by allowing a user who is a remote operator present in a second environment distant from the first environment to operate a remote terminal 300 (an operation terminal).

In the first environment, the robot 100 is connected to the Internet 600 via a wireless router 700. Further, in the second environment, the remote terminal 300 is connected to the Internet 600 via the wireless router 700. The system server 500 is connected to the Internet 600. The robot 100 performs a grasping motion or the like by a hand 124 in accordance with an operation of the remote terminal 300 by the user.

Note that in this embodiment, grasping motions performed by the hand 124 are not limited to motions for simply grasping (holding) an object to be grasped, but also include, for example, the following motions.
a motion for holding and lifting an object to be grasped
a motion for, when an object to be grasped is a knob for a door or a drawer of a cabinet or the like, holding the knob and then opening and closing the door or the drawer
a motion for, when an object to be grasped is a door knob of a door, holding the door knob and then opening and closing the door

The robot 100 shoots the first environment in which the robot 100 is located by a stereo camera 131 (an imaging unit), and transmits the shot image to the remote terminal 300 via the Internet 600. The example of FIG. 1 shows that the robot 100 is shooting a table 400 located in the first environment.

The remote terminal 300 is, for example, a tablet terminal, and includes a display panel 341 on which a touch panel is superimposed. The shot image received from the robot 100 is displayed on the display panel 341, and thus a user can indirectly view the first environment in which the robot 100 is located. Further, a user can input handwritten input information by handwriting to the shot image displayed on the display panel 341. The handwritten input information is, for example, information indicating an object to be grasped which has been requested to be grasped by the hand 124, a way of performing a grasping motion with regard to the object to be grasped, and the like. As a method for inputting the handwritten input information, for example, a method in which the touch panel disposed so as to be superimposed on the display panel 341 is touched with the finger of a user, a touch pen, or the like can be used, but the method therefor is not limited to this. The handwritten input information which a user has input to the shot image is transmitted to the robot 100 via the Internet 600.

Further, the remote terminal 300 has a function for allowing a user to have a conversation with the robot 100 through a text chat. As a method for inputting text information of a user's utterance in the text chat, for example, a method in which a keyboard screen for text input is displayed on the display panel 341 and on the touch panel disposed so as to be superimposed on the display panel 341, the relevant key on the keyboard screen is touched with the finger of a user, a touch pen, or the like can be used, but the method therefor is not limited to this. The text information of the utterance input by a user is transmitted to the robot 100 via the Internet 600. Further, text information of a response utterance to a user's utterance generated by the robot 100 is received from the robot 100 via the Internet 600.

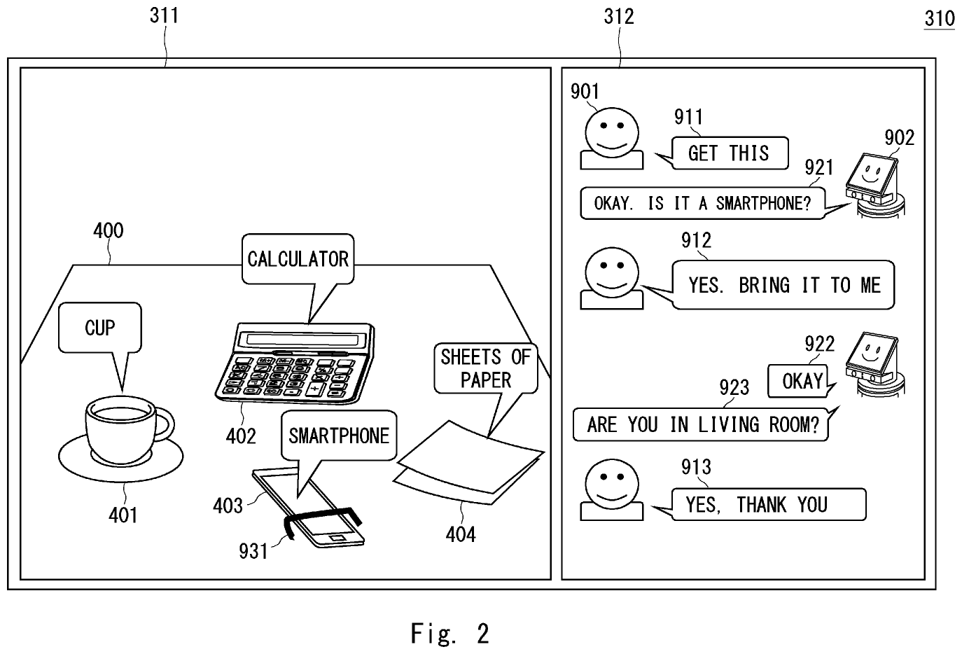

FIG. 2 shows an example of a display screen 310 displayed on the display panel 341 of the remote terminal 300. In the example shown in FIG. 2, a shot image 311 shot by the robot 100 and a chat screen 312 are arranged side by side on the display screen 310.

The shot image 311 shows the table 400, a cup 401 placed on the table 400, a calculator 402, a smartphone 403, and sheets of paper 404. Further, the cup 401, the calculator 402, the smartphone 403, and the sheets of paper 404 are objects that can be grasped by the hand 124. Therefore, the shot image 311 is processed so as to display the names of the objects that can be grasped in a speech balloon form, so that a user can visually recognize the objects that can be grasped. Further, handwritten input information 931 is input to the shot image 311 by a user by handwriting.

Text information obtained from a conversation between a user of the remote terminal 300 and the robot 100 in the form of a text chat is displayed on the chat screen 312. Specifically, the text information of the utterance which a user has input to the remote terminal 300 is displayed as characters in text boxes 911 to 913 of a speech balloon form next to an image 901 that imitates a user. Further, the text information of the response utterance to the user's utterance generated by the robot 100 is displayed as characters in text boxes 921 to 923 of a speech balloon form next to an image 902 that imitates the robot 100.

The robot 100, based on handwritten input information which a user has input to a shot image and a conversation history of a text chat, estimates an object to be grasped which has been requested to be grasped by the hand 124 and estimates a way of performing a grasping motion by the hand 124, the grasping motion having been requested to be performed with regard to the estimated object to be grasped.

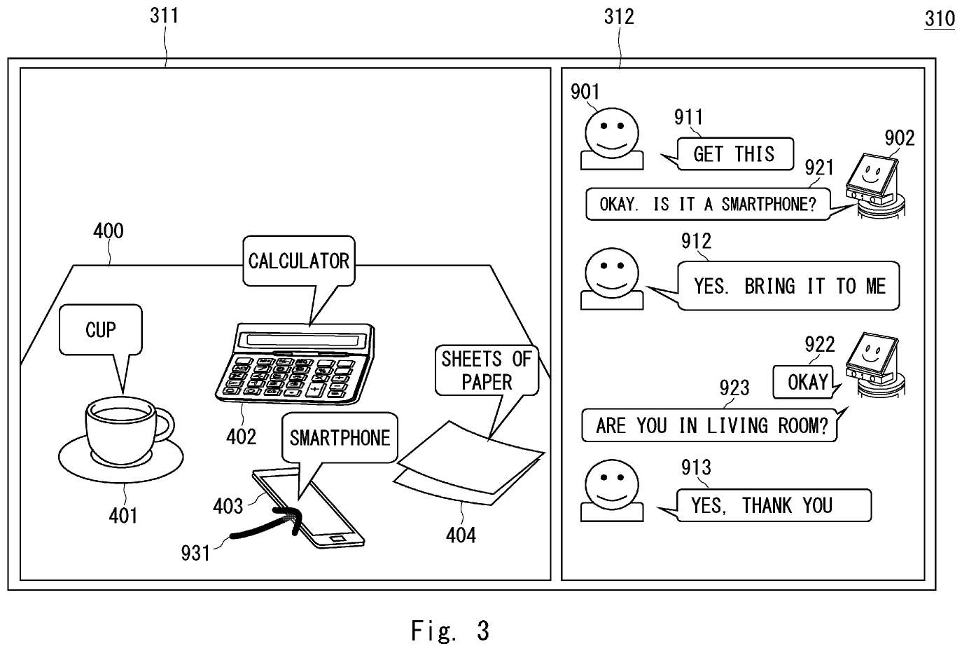

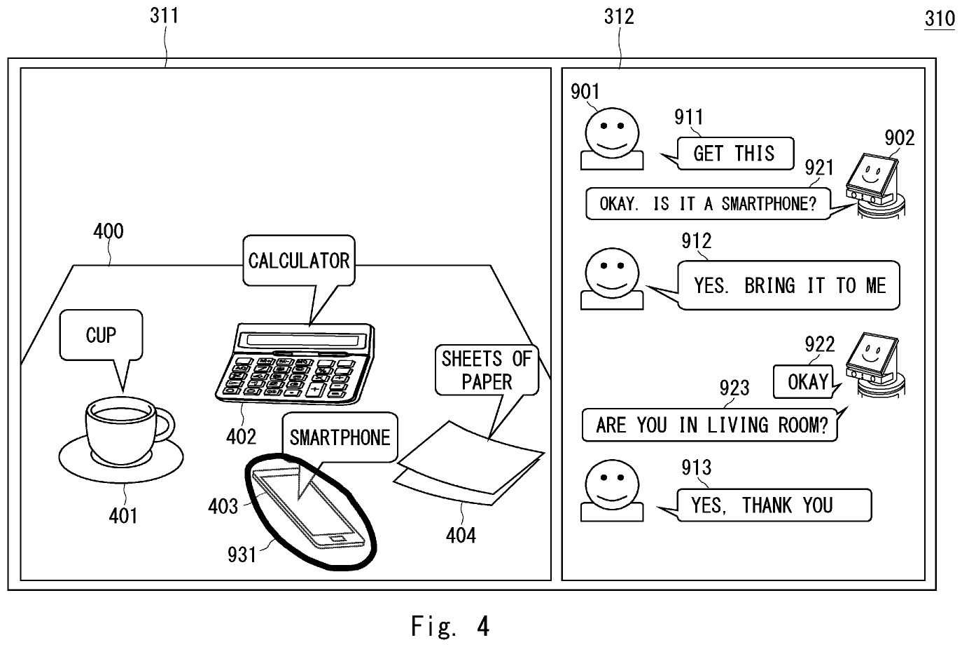

In the example shown in FIG. 2, the handwritten input information 931 is input to a position on the smartphone 403 on the shot image 311. Further, according to the text information pieces input to the text boxes 911, 921, and 912, a grasping motion for holding and lifting an object to be grasped has been requested, the details of which will be described later. Therefore, based on the handwritten input information 931 and the text information pieces input into the text boxes 911, 921, and 912, the robot 100 can estimate that the object to be grasped is the smartphone 403 placed on the table 400, and that a way of performing a grasping motion is to hold and lift the smartphone 403. Note that in the example shown in FIG. 2, the handwritten input information 931 is an image that simulates holding the smartphone 403 from above, but it is not limited to this. The handwritten input information 931 may simply be an image indicating that the smartphone 403 is the object to be grasped, and a user may indicate a way of performing a grasping motion in a conversation with the robot 100 through a text chat. As the image of the handwritten input information 931 indicating that the smartphone 403 is the object to be grasped, for example, an image in which the smartphone 403 is indicated by an arrow as shown in FIG. 3 or an image in which the smartphone 403 is enclosed in any figure (a circle is used in FIG. 4) as shown in FIG. 4 can be used.

Further, the robot 100 may determine whether there is an additionally requested motion to be performed by the robot 100 based on the conversation history of the text chat, and if the robot 100 determines there is an additionally requested motion, the robot 100 may estimate a way of performing this motion.

In the example shown in FIG. 2, according to the text information pieces input to the text boxes 912, 922, 923, and 913, conveyance of the smartphone 403 to a living room has been requested, the details of which will be described later. Therefore, the robot 100 can estimate that the robot 100 has been additionally requested to convey the smartphone 403 held by the grasping motion to the living room based on the text information pieces input to the text boxes 912, 922, 923, and 913.

Thus, in the example shown in FIG. 2, the robot 100 can estimate that the overall motion that has been requested to be performed by the robot 100 is to hold the smartphone 403 and convey it to the living room.

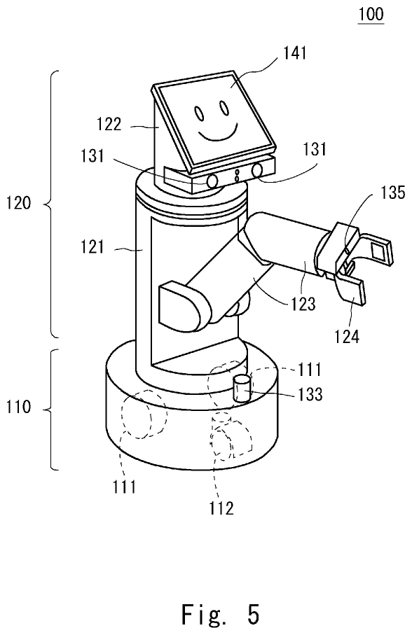

FIG. 5 is an external perspective view showing an example of an external configuration of the robot 100. The robot 100 includes, mainly, a movable base part 110 and a main-body part 120. The movable base part 110 supports two driving wheels 111 and a caster 112, each of which is in contact with a traveling surface, inside its cylindrical housing. The two driving wheels 111 are arranged so that the centers of their rotation axes coincide with each other. Each of the driving wheels 111 is rotationally driven by a motor (not shown) independently of each other. The caster 112 is a driven wheel and is disposed so that its pivotal axis extending from the movable base part 110 in the vertical direction axially supports the wheel at a place away from its rotation axis. Further, the caster 112 follows the movement of the movable base part 110 so as to move in the moving direction of the movable base part 110.

The movable base part 110 includes a laser scanner 133 in a peripheral part of its top surface. The laser scanner 133 scans a certain range on the horizontal plane at intervals of a certain stepping angle and outputs information as to whether or not there is an obstacle in each direction. Further, when there is an obstacle, the laser scanner 133 outputs a distance to the obstacle.

The main-body part 120 includes, mainly, a body part 121 mounted on the top surface of the movable base part 110, a head part 122 placed on the top surface of the body part 121, an arm 123 supported on the side surface of the body part 121, and the hand 124 disposed at the tip of the arm 123. The arm 123 and the hand 124 are driven by motors (not shown) and grasp an object to be grasped. The body part 121 is able to rotate around a vertical axis with respect to the movable base part 110 by a driving force of a motor (not shown).

The head part 122 mainly includes the stereo camera 131 and a display panel 141. The stereo camera 131 has a configuration in which two camera units having the same angle of view are arranged away from each other, and outputs imaging signals of images shot by the respective camera units.

The display panel 141 is, for example, a liquid crystal display panel, and displays an animated face of a pre-defined character and displays information about the robot 100 in the form of text or by using icons. By displaying the face of the character on the display panel 141, it is possible to impart an impression that the display panel 141 is a pseudo face part to people around the robot 100.

The head part 122 is able to rotate around a vertical axis with respect to the body part 121 by a driving force of a motor (not shown). Thus, the stereo camera 131 can shoot an image in any direction. Further, the display panel 141 can show displayed contents in any direction.

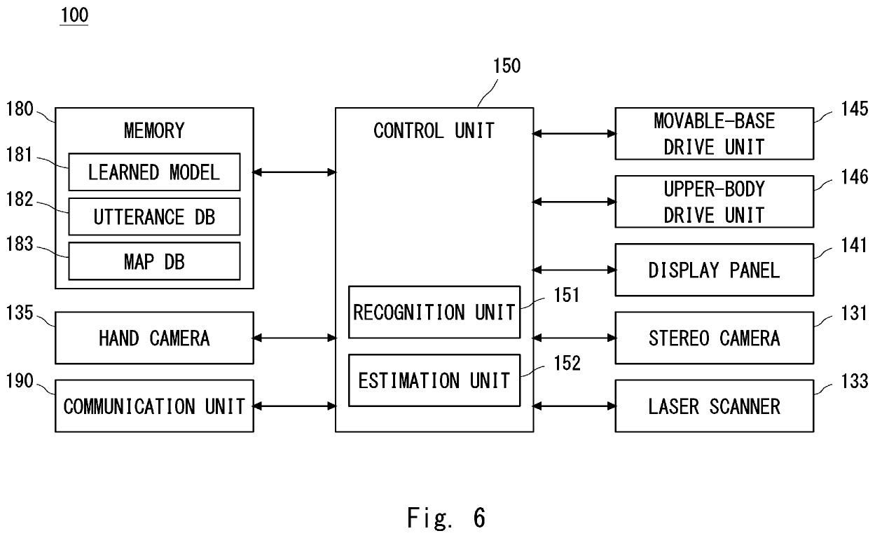

FIG. 6 is a block diagram showing an example of a block configuration of the robot 100. Main elements related to an estimation of an object to be grasped and an estimation of a way of performing a grasping motion will be described below. However, the robot 100 includes elements in its configuration other than the above ones and may include additional elements that contribute to the estimation of an object to be grasped and the estimation of a way of performing a grasping motion.

A control unit 150 is, for example, a CPU (Central Processing Unit) and is included in, for example, a control box disposed in the body part 121. A movable-base drive unit 145 includes the driving wheels 111, and a driving circuit and motors for driving the driving wheels 111. The control unit 150 performs rotation control of the driving wheels by sending a driving signal to the movable-base drive unit 145. Further, the control unit 150 receives a feedback signal such as an encoder signal from the movable-base drive unit 145 and recognizes a moving direction and a moving speed of the movable base part 110.

An upper-body drive unit 146 includes the arm 123 and the hand 124, the body part 121, the head part 122, and driving circuits and motors for driving these components. The control unit 150 performs a grasping motion and a gesture by transmitting a driving signal to the upper-body drive unit 146. Further, the control unit 150 receives a feedback signal such as an encoder signal from the upper-body drive unit 146, and recognizes positions and moving speeds of the arm 123 and the hand 124, and orientations and rotation speeds of the body part 121 and the head part 122.

The display panel 141 receives an image signal generated by the control unit 150 and displays an image thereof. Further, as described above, the control unit 150 generates an image signal of the character or the like and displays an image thereof on the display panel 141.

The stereo camera 131 shoots the first environment in which the robot 100 is located in accordance with a request from the control unit 150 and passes an obtained imaging signal to the control unit 150. The control unit 150 performs image processing by using the imaging signal and converts the imaging signal into a shot image in a predetermined format. The laser scanner 133 detects whether there is an obstacle in the moving direction of the robot 100 in accordance with a request from the control unit 150 and passes a detection signal, which is a result of the detection, to the control unit 150.

A hand camera 135 is, for example, a distance image sensor, and is used to recognize a distance to an object to be grasped, a shape of an object to be grasped, a direction in which an object to be grasped is located, and the like. The hand camera 135 includes an image pickup device in which pixels for performing a photoelectrical conversion of an optical image incident from a target space are two-dimensionally arranged, and outputs a distance to the subject to the control unit 150 for each of the pixels. Specifically, the hand camera 135 includes an irradiation unit for irradiating a pattern light to the target space, and receives the reflected light of the pattern light by the image pickup device to output a distance to the subject captured by each of the pixels based on a distortion and a size of the pattern in the image. Note that the control unit 150 recognizes a state of a wider surrounding environment by the stereo camera 131 and recognizes a state in the vicinity of the object to be grasped by the hand camera 135.

A memory 180 is a nonvolatile storage medium. For example, a solid-state drive is used for the memory 180. The memory 180 stores, in addition to a control program for controlling the robot 100, various parameter values, functions, lookup tables, and the like used for the control and the calculation. In particular, the memory 180 stores a learned model 181, an utterance DB 182, and a map DB 183.

The learned model 181 is a learned model that uses a shot image as an input image and outputs objects that can be grasped shown in the shot image.

The utterance DB 182 is composed of, for example, a storage medium of a hard disk drive, and is a database that stores individual terms organized as a corpus with reproducible utterance data.

The map DB 183 is composed of, for example, a storage medium of a hard disk drive, and is a database that stores map information describing a space in the first environment in which the robot 100 is located.

A communication unit 190 is, for example, a wireless LAN unit and performs radio communication with the wireless router 700. The communication unit 190 receives the handwritten input information input to the shot image and the text information of the user's utterance that are sent from the remote terminal 300 and passes them to the control unit 150. Further, the communication unit 190 transmits to the remote terminal 300, under the control of the control unit 150, a shot image shot by the stereo camera 131 and the text information of the response utterance to the user's utterance generated by the control unit 150.

The control unit 150 performs control of the whole robot 100 and various calculation processes by executing a control program read from the memory 180. Further, the control unit 150 also serves as a function execution unit that executes various calculations and controls related to the control. As such function execution units, the control unit 150 includes a recognition unit 151 and an estimation unit 152.

The recognition unit 151 uses a shot image shot by one of the camera units of the stereo camera 131 as an input image, obtains areas that can be grasped by the hand 124 in the shot image from the learned model 181 read from the memory 180, and recognizes objects that can be grasped.

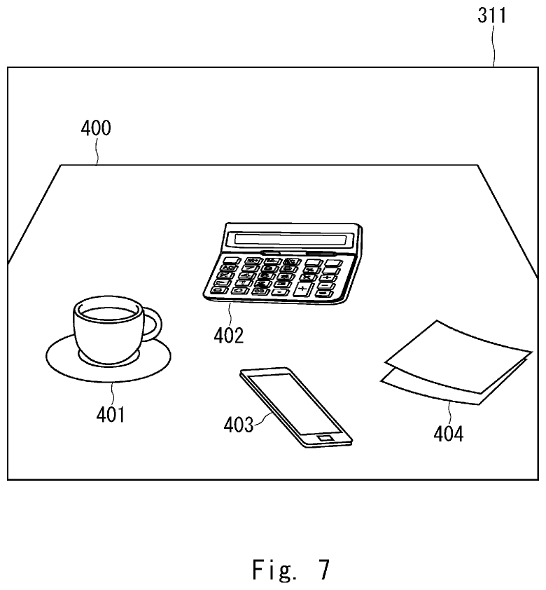

FIG. 7 is a diagram showing an example of the shot image 311 of the first environment which the robot 100 has acquired by the stereo camera 131. The shot image 311 in FIG. 7 shows the table 400, the cup 401 placed on the table 400, the calculator 402, the smartphone 403, and the sheets of paper 404. The recognition unit 151 provides the shot image 311 described above to the learned model 181 as an input image.

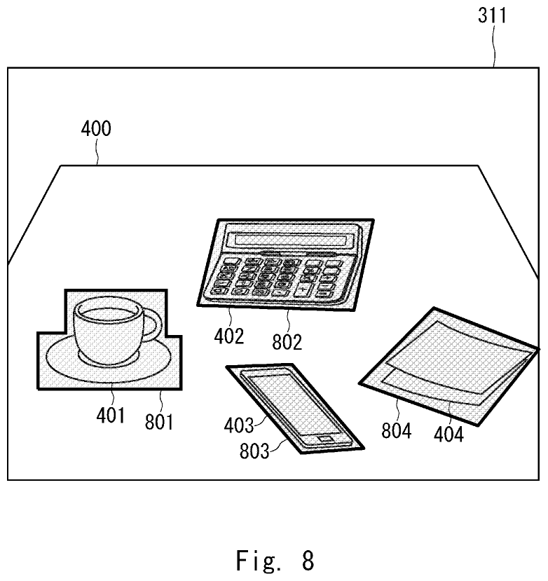

FIG. 8 is a diagram showing an example of areas that can be grasped output by the learned model 181 when the shot image 311 shown in FIG. 7 is used as an input image. Specifically, an area that surrounds the cup 401 is detected as an area 801 that can be grasped, an area that surrounds the calculator 402 is detected as an area 802 that can be grasped, an area that surrounds the smartphone 403 is detected as an area 803 that can be grasped, and an area that surrounds the sheets of paper 404 is detected as an area 804 that can be grasped. Thus, the recognition unit 151 recognizes each of the cup 401, the calculator 402, the smartphone 403, and the sheets of paper 404, which are surrounded by the respective areas 801 to 804 that can be grasped, as an object that can be grasped.

The learned model 181 is a neural network learned from teaching data which is a combination of an image showing objects that can be grasped by the hand 124 and a correct answer to which area of the image is the object that can be grasped. At this time, by preparing the teaching data so as to further indicate the names of the objects that can be grasped, the distances to the objects that can be grasped, and the directions in which the objects that can be grasped are located shown in the image, the learned model 181, which uses the shot image as an input image, can output not only the objects that can be grasped but also the names of the objects that can be grasped, the distances to the objects that can be grasped, and the directions in which the objects that can be grasped are located. Note that the learned model 181 may be a neural network learned by deep learning. Further, teaching data may be added to the learned model 181 as necessary so that it performs additional learning.

Further, the recognition unit 151 may process the shot image when it recognizes the objects that can be grasped, so that a user can visually recognize the objects that can be grasped. As a method for processing the shot image, a method for processing the shot image by displaying the names of the objects that can be grasped in a speech balloon form like in the example of FIG. 2 can be used, but the method therefor is not limited to this.

The estimation unit 152 has a function of having a conversation with a user of the remote terminal 300 in the form of a text chat. Specifically, the estimation unit 152 refers to the utterance DB 182 and generates text information of a response utterance suitable for the utterance which a user has input to the remote terminal 300. At this time, if a user has also input, to the remote terminal 300, handwritten input information to the shot image, the estimation unit 152 also refers to the handwritten input information and generates text information of a response utterance.

The estimation unit 152, based on the handwritten input information which a user has input to the shot image and a conversation history of the text chat, estimates an object to be grasped which has been requested to be grasped by the hand 124 and estimates a way of performing a grasping motion by the hand 124, the grasping motion having been requested to be performed with regard to the estimated object to be grasped. Further, the estimation unit 152 may determine whether there is an additionally requested motion to be performed by the robot 100 based on the conversation history of the text chat, and if the robot 100 determines there is an additionally requested motion, it may estimate a way of performing this motion. At this time, the estimation unit 152 may analyze the content of the handwritten input information and the content of the conversation history of the text chat, and perform the above-described estimation while at the same time confirming the analyzed contents with the remote terminal 300 using the text information of the text chat.

Referring to FIG. 2 as an example, a detailed description is given of an estimation method in which the estimation unit 152 of the robot 100 estimates an object to be grasped, a way of performing a grasping motion, and the like. In the example shown in FIG. 2, first, the robot 100 receives text information (the text box 911) of a user's utterance “Get this” from the remote terminal 300. At this time, objects that can be grasped shown in the shot image 311 shot by the robot 100 are the cup 401, the calculator 402, the smartphone 403, and the sheets of paper 404 that have been recognized by the recognition unit 151. Further, the robot 100 also receives the handwritten input information 931 input to the position on the smartphone 403 on this shot image 311 from the remote terminal 300.

Therefore, the estimation unit 152 analyzes (i.e., determines) that a way of performing a grasping motion is to hold and lift the object to be grasped based on the text information of “Get this”. Further, the estimation unit 152 analyzes (i.e., determines) that the object to be grasped among the objects that can be grasped which the recognition unit 151 has recognized is the smartphone 403 located at the input position of the handwritten input information 931 based on the handwritten input information 931. Note that the estimation unit 152 can recognize the input position of the handwritten input information 931 on the shot image 311 by any method. For example, if the remote terminal 300 includes, in the handwritten input information 931, position information indicating the input position of the handwritten input information 931 on the shot image 311 and transmits this handwritten input information 931, the estimation unit 152 can recognize the input position of the handwritten input information 931 based on this position information. Alternatively, if the remote terminal 300 transmits the shot image 311 processed into a state in which the handwritten input information 931 has been input, the estimation unit 152 can recognize the input position of the handwritten input information 931 based on this shot image 311.

Then, in order to confirm with a user that the object to be grasped is the smartphone 403, the estimation unit 152 generates text information (the text box 921) of a response utterance “Okay. Is it a smartphone?” and transmits the generated text information to the remote terminal 300.

Next, the robot 100 receives text information (the text box 912) of a user's utterance “Yes. Bring it to me” from the remote terminal 300. Thus, the estimation unit 152 estimates that the object to be grasped which has been requested to be grasped by the hand 124 is the smartphone 403, and that a way of performing a grasping motion is to hold and lift the smartphone 403.

Further, as the estimation unit 152 successfully estimates the object to be grasped and the way of performing a grasping motion, it generates text information (the text box 922) of a response utterance “Okay” and transmits the generated text information to the remote terminal 300.

Further, the estimation unit 152 analyzes (i.e., determines), based on the text information of “Bring it to me”, that an additionally requested motion of the robot 100 is to convey the smartphone 403 held by the grasping motion to “me”.

Then, in order to confirm where “me” is, the estimation unit 152 generates text information (the text box 923) of a response utterance “Are you in the living room?” and transmits the generated text information to the remote terminal 300.

Next, the robot 100 receives text information (the text box 913) of a user's utterance “Yes, thank you” from the remote terminal 300. Thus, the estimation unit 152 estimates that the robot 100 has been additionally requested to convey the smartphone 403 to the living room. Consequently, the estimation unit 152 estimates that the overall motion which the robot 100 has been requested to perform is to hold the smartphone 403 and convey it to the living room.

As described above, the estimation unit 152 can estimate an object to be grasped which has been requested to be grasped by the hand 124 and a way of performing a grasping motion by the hand 124, the grasping motion having been requested to be performed with regard to the object to be grasped. Further, if the robot 100 has been requested to perform an additional motion, the estimation unit 152 can estimate a way of performing this motion.

When the aforementioned estimation performed by the estimation unit 152 is completed, the control unit 150 makes preparations to start performing a grasping motion by the hand 124, the grasping motion having been requested to be performed with regard to the object to be grasped. Specifically, first, the control unit 150 drives the arm 123 to a position where the hand camera 135 can observe an object to be grasped. Next, the control unit 150 causes the hand camera 135 to shoot the object to be grasped and thus recognizes the state of the object to be grasped.

Then, the control unit 150 generates a trajectory of the hand 124 for enabling a grasping motion that has been requested to be performed with regard to the object to be grasped based on the state of the object to be grasped and a way of performing the grasping motion by the hand 124. At this time, the control unit 150 generates a trajectory of the hand 124 so that it satisfies predetermined grasping conditions. The predetermined grasping conditions include the condition at the time when the hand 124 grasps the object to be grasped, condition of the trajectory of the hand 124 until the hand 124 grasps the object to be grasped, and the like. Examples of the conditions at the time when the hand 124 grasps the object to be grasped include preventing the arm 123 from extending too much when the hand 124 grasps the object to be grasped. Further, examples of the conditions of the trajectory of the hand 124 until the hand 124 grasps the object to be grasped include that the hand 124 describes a straight trajectory when the object to be grasped is a knob for a drawer.

When the control unit 150 generates a trajectory of the hand 124, it transmits a driving signal corresponding to the generated trajectory to the upper-body drive unit 146. The hand 124 performs a grasping motion with regard to the object to be grasped in response to the driving signal.

Note that when the estimation unit 152 has estimated a way of performing a motion which the robot 100 has been additionally requested to perform, the control unit 150 causes the robot 100 to perform the additionally requested motion before or after generation of a trajectory of the hand 124 and a grasping motion of the hand 124. At this time, depending on a motion which the robot 100 has additionally been requested to perform, a motion for moving the robot 100 may be required. For example, as shown in the example of FIG. 2, when a motion for holding and conveying an object to be grasped has additionally been requested, it is necessary to move the robot 100 to a conveyance destination. Further, when there is some distance between the current position of the robot 100 and the position of the object to be grasped, it is necessary to move the robot 100 to the vicinity of the object to be grasped.

When a motion for moving the robot 100 is required, the control unit 150 acquires, from the map DB 183, map information describing a space in the first environment where the robot 100 is located in order to generate a route for moving the robot 100. The map information may describe, for example, the position and the layout of each room in the first environment. Further, the map information may describe obstacles such as cabinets and tables located in each room. However, in regard to obstacles, it is also possible to detect whether there are obstacles in the moving direction of the robot 100 by a detection signal received from the laser scanner 133. Further, when there is some distance between the current position of the robot 100 and the position of the object to be grasped, it is possible, depending on the learned model 181, to obtain the distance to the object to be grasped and the direction in which the object to be grasped is located from the shot image acquired by the stereo camera 131. Note that the distance to the object to be grasped and the direction in which the object to be grasped is located may be obtained by performing an image analysis of the shot image of the first environment or from information received from other sensors.

Therefore, when the control unit 150 causes the robot 100 to move to the vicinity of the object to be grasped, the control unit 150 generates, based on the map information, the distance to the object to be grasped and the direction in which the object to be grasped is located, the presence or absence of obstacles, and the like, a route for the robot 100 to move from its current position to the vicinity of the object to be grasped while avoiding obstacles. Further, when the control unit 150 causes the robot 100 to move to the conveyance destination, the control unit 150 generates, based on the map information, the presence or absence of obstacles, and the like, a route for the robot 100 to move from its current position to the conveyance destination while avoiding obstacles. Then, the control unit 150 transmits a driving signal corresponding to the generated route to the movable-base drive unit 145. The movable-base drive unit 145 moves the robot 100 in response to the driving signal. Note that when there is, for example, a door in the route to the conveyance destination, the control unit 150 needs to generate a trajectory of the hand 124 for the robot 100 to hold the door knob near the door and then open and close the door, and also needs to control the hand 124 corresponding to the generated trajectory. In this case, the generation of the trajectory and the control of the hand 124 may be performed by using, for example, a method similar to that described above.

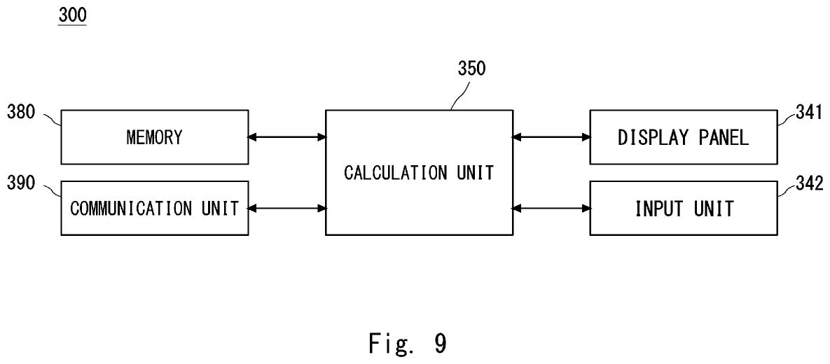

FIG. 9 is a block diagram showing an example of a block configuration of the remote terminal 300. Main elements related to a process for allowing a user to input handwritten input information to a shot image received from the robot 100 and a process for allowing a user to have a conversation with the robot 100 through a text chat will be described below. However, the robot 100 includes elements in its configuration other than the above ones and may include additional elements that contribute to the process for allowing a user to input handwritten input information to a shot image received from the robot 100 and the process for allowing a user to have a conversation with the robot 100 through a text chat.

A calculation unit 350 is, for example, a CPU and performs control of the whole remote terminal 300 and various calculation processes by executing a control program read from a memory 380. The display panel 341 is, for example, a liquid crystal panel, and displays, for example, a shot image sent from the robot 100 and a chat screen of a text chat. Further, the display panel 341 displays, on the chat screen, text information of the utterance input by a user and text information of the response utterance sent from the robot 100.

An input unit 342 includes a touch panel disposed so as to be superimposed on the display panel 141 and a push button provided on a peripheral part of the display panel 141. The input unit 342 passes, to the calculation unit 350, the handwritten input information and the text information of the utterance which a user has input by touching a touch panel. Examples of the handwritten input information and the text information are as shown in FIG. 2.

The memory 380 is a nonvolatile storage medium. For example, a solid-state drive is used for the memory 380. The memory 380 stores, in addition to a control program for controlling the remote terminal 300, various parameter values, functions, lookup tables, and the like used for the control and the calculation.

A communication unit 390 is, for example, a wireless LAN unit and performs radio communication with the wireless router 700. The communication unit 390 receives the shot image and the text information of the response utterance sent from the robot 100 and passes them to the calculation unit 350. Further, the communication unit 390 cooperates with the calculation unit 350 to transmit handwritten input information and text information of a user's utterance to the robot 100.

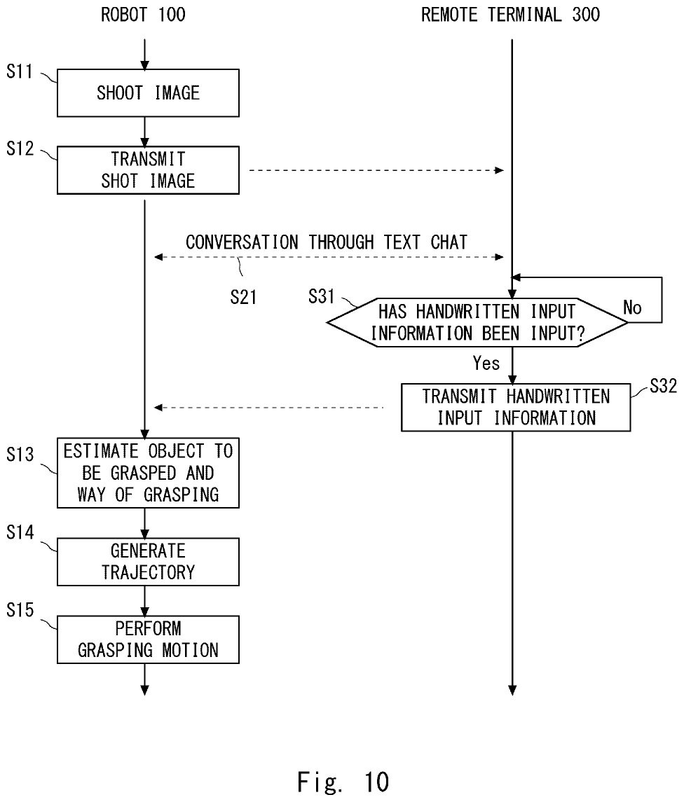

Next, an overall description is given of processes performed by the remote control system 10 according to this embodiment. FIG. 10 is a flowchart showing an example of an overall flow of the processes performed by the remote control system 10 according to this embodiment. The flow on the left side thereof represents a flow of processes performed by the robot 100, and the flow on the right side thereof represents a flow of processes performed by the remote terminal 300. Further, exchanges of handwritten input information, a shot image, and text information of a text chat performed via the system server 500 are indicated by dotted-line arrows.

The control unit 150 of the robot 100 causes the stereo camera 131 to shoot the first environment in which the robot 100 is located (Step S11), and transmits the shot image to the remote terminal 300 via the communication unit 190 (Step S12).

When the calculation unit 350 of the remote terminal 300 receives the shot image from the robot 100 via the communication unit 390, the calculation unit 350 displays the received shot image on the display panel 341.

After that, a user makes a conversation with the robot 100 through a text chat on the remote terminal 300 (Step S21). Specifically, when a user inputs text information of his/her utterance via the input unit 342 which is a touch panel, the calculation unit 350 of the remote terminal 300 displays the text information on the chat screen of the display panel 341 and transmits the text information to the robot 100 via the communication unit 390. Further, when the calculation unit 350 receives text information of a response utterance from the robot 100 via the communication unit 390, the calculation unit 350 displays the text information on the chat screen of the display panel 341.

Further, the calculation unit 350 of the remote terminal 300 causes the display panel 341 to transit to a state in which handwritten input information input to the shot image can be received (Step S31). When a user inputs handwriting input information to the shot image via the input unit 342 which is a touch panel (Yes in Step S31), the calculation unit 350 transmits the handwriting input information to the robot 100 via the communication unit 390 (Step S32).

Upon receiving the handwritten input information which a user has input to the shot imager from the remote terminal 300, the estimation unit 152 of the robot 100, based on this handwritten input information and a conversation history of the text chat, estimates an object to be grasped which has been requested to be grasped by the hand 124 and estimates a way of performing a grasping motion by the hand 124, the grasping motion having been requested to be performed with regard to the estimated object to be grasped (Step S13). At this time, the estimation unit 152 acquires from the recognition unit 151 the information of the objects that can be grasped shown in the shot image to which the handwritten input information is input, and estimates the object to be grasped from among the objects that can be grasped based on the handwritten input information and the conversation history of the text chat. Further, the estimation unit 152 analyzes the content of the handwritten input information and the content of the conversation history of the text chat, and performs the above-described estimation while at the same time confirming the analyzed contents with the remote terminal 300 using the text information of the text chat.

After that, the control unit 150 of the robot 100 generates a trajectory of the hand 124 for enabling the grasping motion that has been requested to be performed with regard to the object to be grasped (Step S14). When the control unit 150 has generated a trajectory of the hand 124, the control unit 150 controls the upper-body drive unit 146 in accordance with the generated trajectory, whereby the grasping motion is performed by the hand 124 with regard to the object to be grasped (Step S15).

Note that in Step S13, the estimation unit 152 may determine whether there is an additionally requested motion to be performed by the robot 100 based on the conversation history of the text chat, and if the robot 100 determines there is an additionally requested motion, it may estimate a way of performing this motion. The robot 100 may analyze the content of the conversation history of the text chat and perform this estimation while at the same time confirming the analyzed content with the remote terminal 300 using the text information of the text chat.

If the estimation unit 152 has estimated a way of performing a motion which the robot 100 has been additionally requested to perform, the control unit 150 causes the robot 100 to perform the additionally requested motion before or after Steps S14 and S15. When a motion for moving the robot 100 is required for performing such an above motion, the control unit 150 generates a route for moving the robot 100. Then, the control unit 150 transmits a driving signal corresponding to the generated route to the movable-base drive unit 145. The movable-base drive unit 145 moves the robot 100 in response to the driving signal.

As described above, according to this embodiment, the estimation unit 152, based on the handwritten input information which a user has input to the shot image obtained by shooting the environment in which the robot 100 is located and a conversation history of the text chat, estimates an object to be grasped which has been requested to be grasped by the hand 124 and estimates a way of performing a grasping motion by the hand 124, the grasping motion having been requested to be performed with regard to the estimated object to be grasped.

By this configuration, it is possible to have the robot 100 perform a grasping motion by a remote control without the need for a user to recollect predetermined instruction figures and input them by handwriting. Thus, it is possible to implement the remote control system 10 that enables a more intuitive operation.

Further, according to this embodiment, the estimation unit 152 may analyze the content of the handwritten input information input to the shot image and the content of the conversation history of the text chat, and confirm the analyzed contents with the remote terminal 300 (a user) using the text information of the text chat.

By this configuration, it is possible to communicate with a user in regard to the operation of a grasping motion while at the same time confirming the intention of the user through a text chat. Thus, it is possible to implement the remote control system 10 that enables an intuitive operation in which the intention of a user is further reflected.

Note that the present disclosure is not limited to the above-described embodiment and can be modified as appropriate without departing from the spirit of the present disclosure.

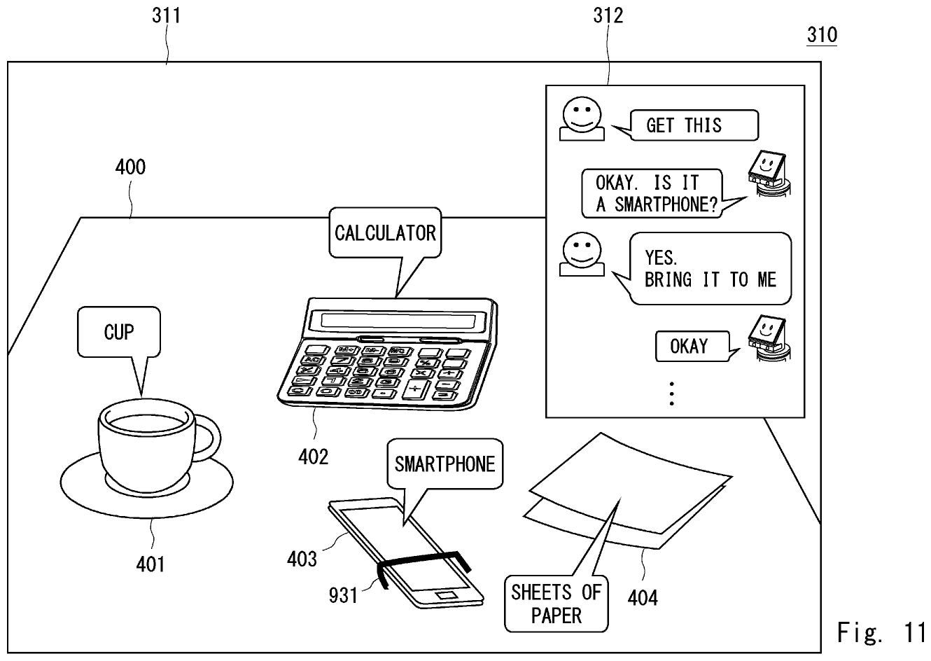

For example, in the above-described embodiment, the display screen 310 displayed on the display panel 341 of the remote terminal 300 is, for example, a screen on which the shot image 311 and the chat screen 312 are arranged side by side as shown in FIG. 2, but this is merely one example. The display screen 310 may be, for example, a screen in which the chat screen is superimposed on the shot image. FIG. 11 is a diagram showing an example of the display screen 310 in which the chat screen 312 is superimposed on the shot image 311.

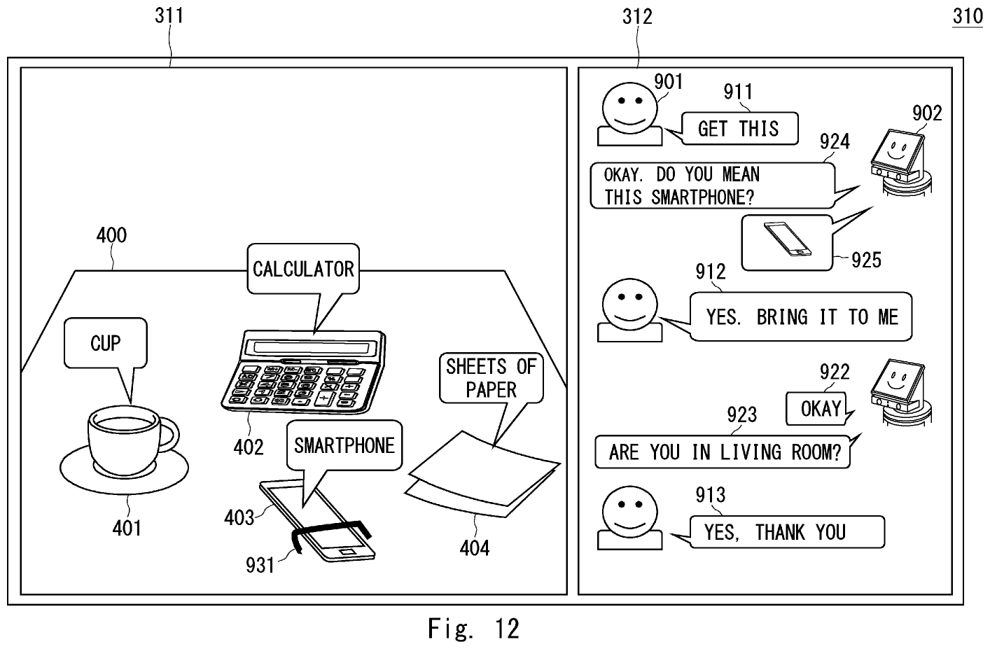

In the above-described embodiment, the estimation unit 152 confirms the analyzed content of the handwritten input information input to the shot image with the remote terminal 300 (a user) by using the text information of the text chat. At this time, the object to be grasped analyzed from the handwritten input information may be confirmed with the remote terminal 300 (a user) by cutting out an image of the object to be grasped from the shot image and displaying it on the chat screen. FIG. 12 is a diagram showing an example in which an image of the object to be grasped analyzed from the handwritten input information is displayed on the chat screen. In the example shown in FIG. 12, in order to confirm with a user that the object to be grasped is the smartphone 403 based on the analysis of the handwritten input information 931, the estimation unit 152 transmits, to the remote terminal 300, text information (a text box 924) of a response utterance “Okay. Do you mean this smartphone?” and an image (a text box 925) of the smartphone 403 cut out from the shot image 311 and displays the text information and the image on the chat screen 312 of the display panel 341.

Further, in the above-described embodiment, an example in which one piece of handwritten input information is input to the shot image has been described, but this is merely one example. A plurality of handwritten input information pieces may be input to the shot image. When a plurality of handwritten input information pieces are input to the shot image, the estimation unit 152 may analyze each of the plurality of handwritten input information pieces, and estimate objects to be grasped and ways of performing grasping motions while at the same time confirming the contents of the analysis with the remote terminal 300 (a user) using the text information of the text chat. At this time, the estimation unit 152 may estimates that the order of performing the grasping motions is the order in which the handwritten input information pieces corresponding to the grasping motions are input. Alternatively, the estimation unit 152 may estimate the order of performing the grasping motions while at the same time confirming it with the remote terminal 300 (a user) using the text information of the text chat.

Further, in the above-described embodiment, the robot 100 includes the recognition unit 151 and the estimation unit 152, but this is merely an example. The functions of the recognition unit 151 and the estimation unit 152 other than the function of having a conversation with a user of the remote terminal 300 may be included in the remote terminal 300 or in the system server 500.

Further, in the above-described embodiment, a user inputs text information of his/her utterance by touching the touch panel disposed so as to be superimposed on the display panel 341 of the remote terminal 300, but this is merely an example. For example, a user may utter in a microphone or the like of the remote terminal 300, and the remote terminal 300 may recognize the content of this user's utterance by using a common voice recognition technique, convert it into text information, and use the converted text information as text information of a user's utterance.

Further, in the above-described embodiment, the robot 100 and the remote terminal 300 exchange a shot image, handwritten input information, and text information of a text chat via the Internet 600 and the system server 500, but this is merely an example. The robot 100 and the remote terminal 300 may exchange a shot image, handwritten input information, and text information of a text chat by direct communication.

Further, in the above-described embodiment, the imaging unit (the stereo camera 131) included in the robot 100 is used, but this is merely an example. The imaging unit may be any imaging unit provided at any place in the first environment in which the robot 100 is located. Further, the imaging unit is not limited to a stereo camera and may be a monocular camera or the like.

Further, in the above-described embodiment, the example in which the device to be operated is the robot 100 including the hand 124 at the tip of the arm 123 as an end effector has been described, but this is merely one example. The device to be operated may be any device including an end effector and performing a grasping motion by using the end effector. Further, the end effector may be a grasping part (e.g., a suction part) other than a hand. Further, in the above-described embodiment, it has been described that in the robot 100 and the remote terminal 300, the CPU executes the control program read from the memory, thereby performing control and calculation processes. In the system server 500, like in the robot 100 and the remote terminal 300, the CPU may also execute the control program read from the memory, thereby performing control and calculation processes.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A remote control system configured to remotely control a device to be operated comprising an end effector, the remote control system comprising:
an imaging unit configured to shoot an environment in which the device to be operated is located;
an operation terminal having a function for displaying a shot image of the environment shot by the imaging unit and receiving handwritten input information input to the displayed shot image, and allowing a user to have a conversation with the device to be operated through a text chat; and
an estimation unit configured to, based on the handwritten input information input to the shot image and a conversation history of the text chat, estimate an object to be grasped which has been requested to be grasped by the end effector and estimate a way of performing a grasping motion by the end effector, the grasping motion having been requested to be performed with regard to the object to be grasped.

2. The remote control system according to claim 1, wherein the estimation unit analyzes a content of the handwritten input information input to the shot image, and confirms the content of the analysis with the operation terminal by using text information of the text chat.

3. The remote control system according to claim 1, further comprising a recognition unit configured to recognize objects that can be grasped by the end effector based on the shot image, wherein the estimation unit estimates the object to be grasped from among the objects that can be grasped which the recognition unit has recognized.

4. A remote control method performed by a remote control system configured to remotely control a device to be operated comprising an end effector, the remote control method comprising:
shooting an environment in which the device to be operated is located;
receiving, by an operation terminal displaying a shot image of the environment, handwritten input information input to the displayed shot image;
causing the device to be operated to have a conversation with a user of the operation terminal through a text chat; and
based on the handwritten input information input to the shot image and a conversation history of the text chat, estimating an object to be grasped which has been requested to be grasped by the end effector and estimating a way of performing a grasping motion by the end effector, the grasping motion having been requested to be performed with regard to the object to be grasped.

5. A non-transitory computer readable medium storing a program for causing a computer to, based on handwritten input information input to a shot image obtained by shooting an environment in which a device to be operated comprising an end effector is located, the shot image being displayed on an operation terminal, and a conversation history of a text chat between the device to be operated and a user of the operation terminal, estimate an object to be grasped which has been requested to be grasped by the end effector and estimate a way of performing a grasping motion by the end effector, the grasping motion having been requested to be performed with regard to the object to be grasped.
